(19) United States
(12) Patent Application Publication
(10) Pub. No.: US 2026/0258774 A1
(43) Pub. Date: Sep. 3, 2026

(54) STEEP PYRAMIDAL STRUCTURE OF ELECTRICITY

(71) Applicant: MASOUD ZALPOUR MOGHADAM, I, Tehran (IR)

(72) Inventor: MASOUD ZALPOUR MOGHADAM, I, Tehran (IR)

(73) Assignee: MASOUD ZALPOUR MOGHADAM, I, Tehran (IR)

(21) Appl. No.: 18/875,302

(22) PCT Filed: Jul. 22, 2023
(86) PCT No.: PCT/IB2023/057479

§ 371 Date: Dec. 16, 2024

(51) Int. Cl. F03B 13/06; F03B 17/00

(52) U.S. Cl. CPC F03B 13/06; F03B 17/005; F05B 2250/21; F05B 2260/422

(57) ABSTRACT

The sloping pyramidal structure of electricity generation with the mechanism of water turbines and the constant cycle of water rotation in stepped ponds is pyramid-shaped, which in each floor is designed a pool to store water for the rotation of the turbine blades for the electricity generation. The number of sides of this pyramid is variable and can continue from three sides to infinity. In this structure, based on the amount of electricity produced, the number of pumps and their flow rates are directly related to the turbines and generators of each floor. Also, the number of turbines and generators varies based on the amount of water volume in each floor.

### TECHNICAL FIELD

Electronics/It is a stepped pyramid structure for electricity generation, which is produced electricity with a constant water cycle and the rotation of water turbines inside this structure.

### BACKGROUND ART

Today, the use of renewable energy, especially electricity, is very significant; this issue has caused various methods to be proposed and tested for electricity generation, but these methods have many problems, some of which have very heavy costs, high fuel consumption, high depreciation, and high maintenance costs, and also, we require high costs to improve the capacity. Therefore, the alleged structure was designed with the following objectives:
1. The possibility of generating electricity from a standing cycle
2. Increasing the productivity of the electricity production structure
3. The possibility of upgrading to the required level at a low cost
4. Reducing the cost of construction and maintenance
5. No need for highly advanced foreign equipment and technologies
6. Not need for a large place
7. No need for fossil fuels to manufacture electricity
8. Use of structures instead of erosion facilities
9. The possibility of attracting tourists with the construction of this structure

### SUMMARY OF INVENTION

The sloping pyramidal structure of electricity generation with the mechanism of water turbines and the constant cycle of water rotation in stepped ponds is pyramid-shaped, which in each floor is designed a pool to store water for the rotation of the turbine blades for the electricity generation. The number of sides of this pyramid is variable and can continue from three sides to infinity. In this structure, based on the amount of electricity produced, the number of pumps and their flow rates are directly related to the turbines and generators of each floor. Also, the number of turbines and generators varies based on the amount of water volume in each floor. The turbines are placed on the wall and in the lower part of each floor and the maximum power is entered into the turbine and the highest efficiency of the turbine is used. The application of the claimed invention is to produce electricity with a constant water cycle. It should be noted that these stepped ponds can be used on all inclined surfaces and conical structures, and the sides of the pyramid and the number of floors can be increased and decreased, and there is no limit.

### TECHNICAL PROBLEM

The inclined pyramidal structure of electricity generation with the mechanism of water turbines and the constant cycle of water rotation in stepped ponds is a pyramidal structure in the form of floors, and in each floor is designed a pool to store water for the rotation of the blades of the electricity generation turbine.

The number of sides of this pyramid is variable and can start from three sides and continue to infinity. In this structure, the amount of electricity produced, the number of pumps and their flow rates are directly related to the turbine and generators of each floor. Also, the number of turbines and generators varies based on the calculation of the volume of water available in each floor.

The turbines are placed on the wall and in the lower part of each floor so that the maximum power is entered into the turbine and the highest efficiency of the turbine is used. This structure is calculated and designed based on the amount of electricity produced and consists of two main parts:
1—The following section: This section is considered for pumping water to the floors and the number of installations (pumps) is calculated based on the flow rate of the structure.
2—The pyramidal part or the upper part: In this section, the structure is in the shape of a pyramid, with a number of floors placed on top of each other in the shape of a pyramid.

### SOLUTION TO PROBLEM

Steep pyramidal structure of electricity production with water turbine mechanism and constant cycle of water circulation in stepped ponds. First, the structure is filled through the water of the area, until all the floors and tanks in the facilities section are filled with water (On each floor, for each pool, there is a level meter to measure the amount of water in the pool). Then the electric valve of the upper turbines is opened and the available water hits the blades and causes the turbine to rotate, and the exiting water of the turbine flows into the lower pool and the turbines do this one by one until each turbine reaches its best efficiency. At the base of the pyramid, the water coming out of the pools is collected and directed through pipes into the reservoirs of each side of the pyramid. The water in the tank is transported to the upper floors using water pumps (In order to increase the water flow rate, the compressed air produced by the air compressor unit has been used). (By using the above method, the amount of electricity consumed by the system is reduced). Based on the amount of water consumed by each floor in the way of the water pumping pipe, an outlet is assigned to each floor and an electric valve is installed in each of these pipes to control the flow of water in each floor based on the consumption. If a lot of water accumulates behind the pool of each floor in the system, a pipe and an electric valve are has installed at the head of the wall of each floor that transfer the excess water to other floors. (This can also be used when the turbines fail) In order to increase the output efficiency, each turbine is connected to a gearbox that increases the rotation rate and transfers it to a generator. (It should be noted that each stepped pond can be used on all inclined surfaces and conical structures, and the sides of the pyramid and the number of floors can be increased or decreased; and there is no limit).

### ADVANTAGEOUS EFFECTS OF INVENTION

1. Until now, there has been no dedicated structure for electricity generation, and mostly hydro turbines have been used to generate electricity by placing them in the walls of dams, etc.
2. The stepped pyramid structure with the property of creating pressure with the water inside the ponds on the existing turbines due to the slope and gravity of the earth, makes it possible to produce electricity.
3. The constant cycle in this structure leads to the creation of a permanent cycle.

In this cycle, it is possible to extend and recharge the case while working to produce electricity with a saved and certain amount of water, and it also allows the possibility of increasing the productivity of the available water volume.
4. It is possible to supply the electricity required by the structure itself and storable electricity.

### BRIEF DESCRIPTION OF DRAWINGS

FIG. 1: Perspective overview

FIG. 2: Side view

Number 1: The upper part or the main pyramid

Number 2: The lower part of the structure (facilities part)

FIG. 3: Top view

FIG. 4: Perspective view of the electricity generation sector

Number 3: Smart solenoid valve

Number 4: Turbine

Number 5: Gearbox

Number 6: Generator

Number 7: The entrance of the filling pipe of the floors

FIG. 5: Perspective view of the overflow section

Number 8: Smart solenoid valve for overflow the excess water

FIG. 6: Perspective view of the pyramid structure and all tools

FIG. 7: Side cut view

Number 9: Intelligent electric valve filling the floors

Number 10: Pool part of the structure

Number 11: floor filler pipe

Number 12: Pool wall

Number 13: Transfer pipe (from the bottom of the pool to the water tank)

Number 14: Separating wall

FIG. 8: Perspective view of the lower part (facilities)

Number 15: Transfer pipe (from the bottom of the pool to the water tank)

Number 16: Water tank

Number 17: Floor filling pipe

FIG. 9: Perspective view of the details of the lower part

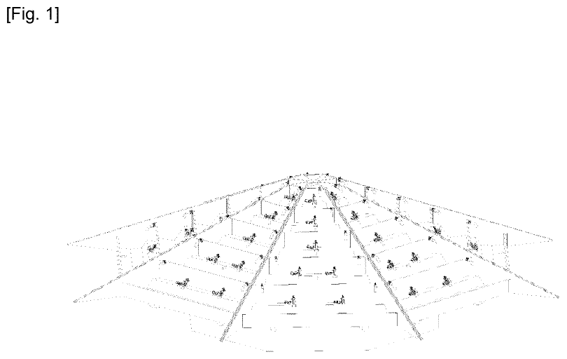

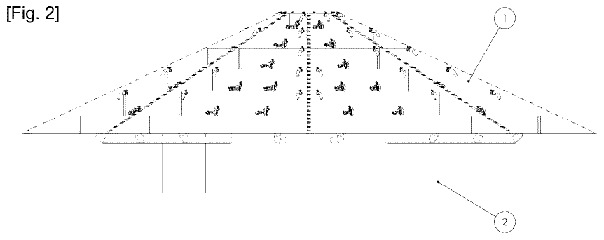

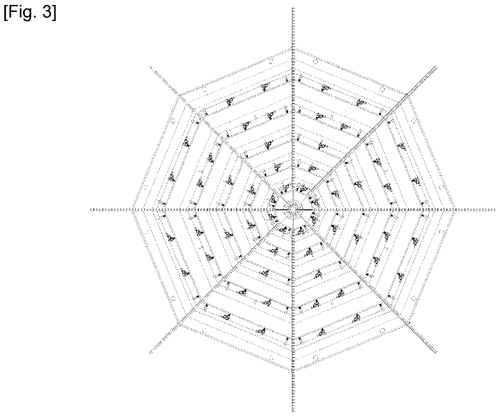

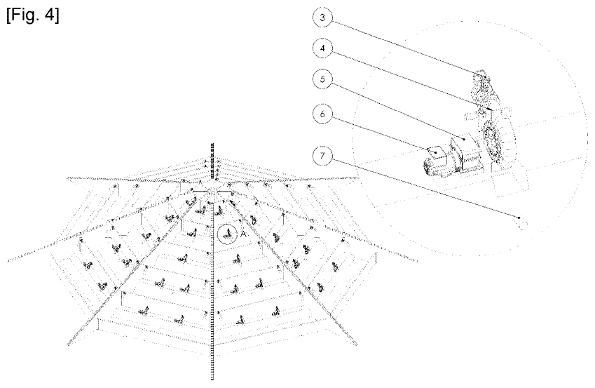

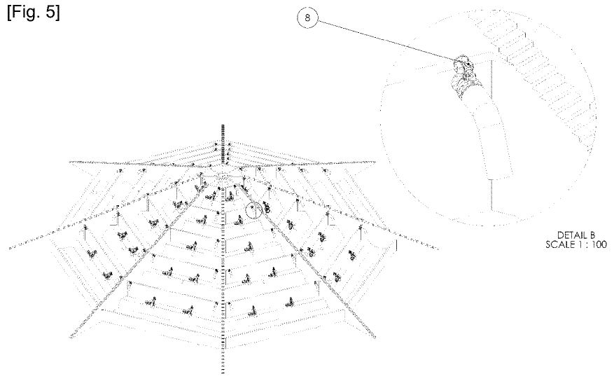

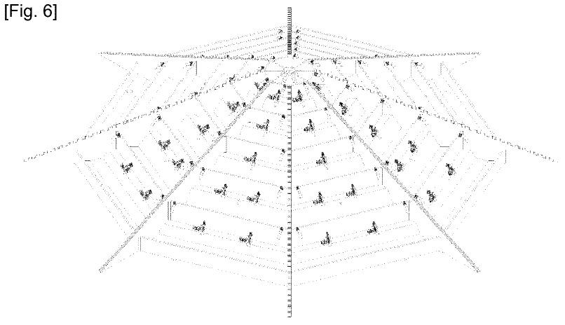

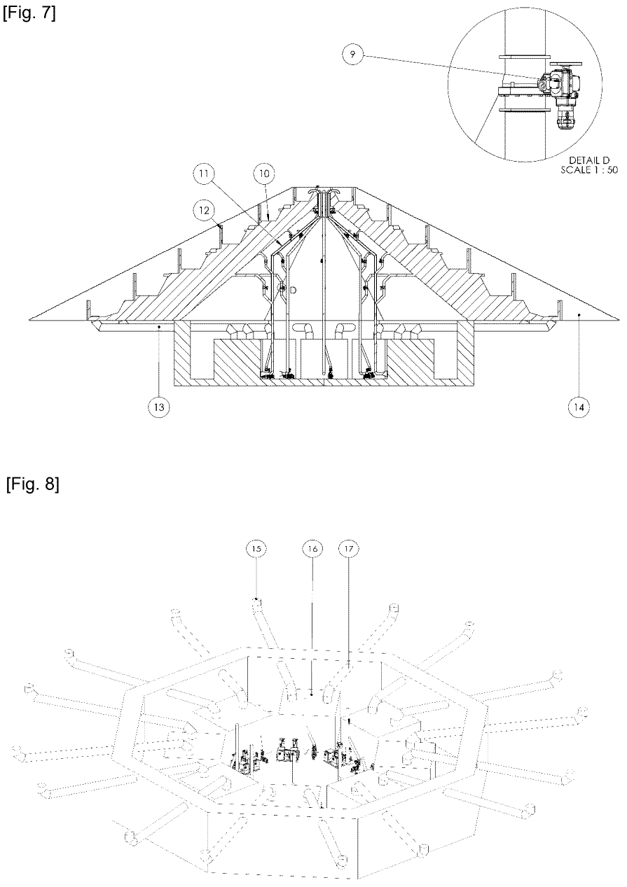

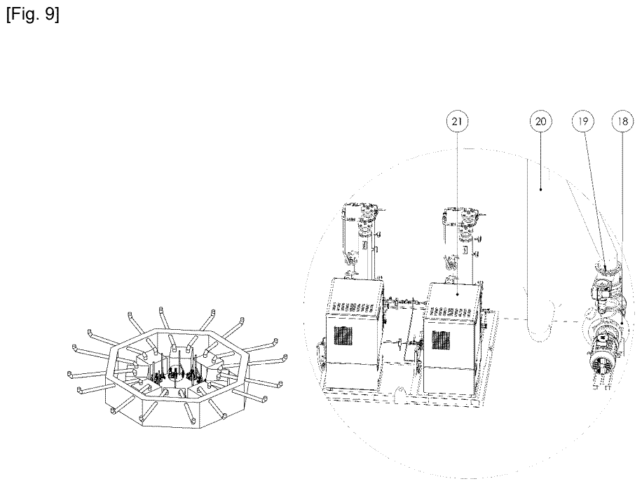

Number 18: Floor water pump

Number 19: Smart solenoid valve

Number 20: Pipe under the pressure of air (for filling the floors)

Number 21: Wind compressor

### DESCRIPTION OF EMBODIMENTS

The use of this structure is very simple and automatic.

At first, the structure is Dewatering through the area water until all the floors and tanks in the facilities are filled with water. There is a level gauge on each floor for each pool to measure the water level.

Then the electric valve of the upper turbines is opened and the available water hits the blades and causes the turbine to rotate, and the exiting water flows into the lower pool and the turbines do this one by one until each turbine reaches its best efficiency.

At the base or from the bottom of the pyramid, the water that coming out of the pools is collected and directed through pipes into the reservoirs of each side of the pyramid.

The water in the tank is transported to the upper floors by water pumps. To increase the water flow, has been used compressed air that is produced by the air compressors. In this way, the amount of electricity consumed by the system is reduced.

### Examples

This inventive structure has the ability to attract tourists and it is possible to do tree work and beautification on the pyramid. Also, due to the interesting mechanism and fountain or waterfall, a series of water parts can be installed in the form of a fountain, which leads to the creation of a suitable tourism-tourist atmosphere and helps in attracting tourists.

### Industrial Applicability

The application of the claimed invention is to generate electricity with a constant water cycle.

### Reference Signs List

### Reference to Deposited Biological Material

### Sequence Listing Free Text

### Citation List

### Patent Literature

PTL1:

### Non Patent Literature

NPL1:

1. The inclined pyramidal structure produces electricity with the mechanism of water turbines and the constant cycle of water circulation in stepped ponds, which is a sloping pyramidal structure in the form of floors, with a pool in each floor to store water to rotate the blades. The turbine and electricity generation is designed in a stepped manner, the components of which are as follows:
The lower part is considered for pumping water to the floors and the number of facilities is calculated based on the structure's discharge.
The upper sloping pyramid-shaped part, which is a pyramidal structure and a number of floors are placed on top of each other in the form of a pyramid.
Turbine to generate electricity at the outlet of water from stepped ponds.
Level gauge device to measure the amount of water in the pool.
Compressor to produce compressed air.
The upper part or the main pyramid.
Smart solenoid valve to control water entry and exit.
Gearbox for moving turbines.
Generator to convert rotational motion into electricity
Floor filler pipe entrance
Smart electric valve for excess water
Smart electric valve filling the floors
The pool part of the structure
Floor filler pipe
Pool wall
Transfer pipe (from the bottom of the pool to the water tank)
Separating wall
Transfer pipe (from the bottom of the pool to the water tank)
Water reservoir
Filling pipe tee
smart electric valve
Under air pressure tube to fill floors
Air compressor to fill the volume of pipes and create pressure

2. According to claim number one, in the alleged structure, at first the structure is filled through the area water until all the floors and tanks in the facilities section are filled with water. Then the electric valve of the above turbines is opened and the existing water hits the blades and causes the turbine to rotate. Then the output water enters the lower pool and the turbines at the output of the stepped ponds operate one by one in this way. This procedure continues until each turbine reaches its best efficiency and the exiting water is collected at the first floor from the bottom of the pyramid. Then the water is directed through the pipes into the tanks of each side of the pyramid and the water in the tank is transferred to the upper floors (it is used to increase the flow of water and in this way the amount of electricity consumed by the system is reduced.)

3. According to claim number one and two, a compressor has been used to produce compressed air to increase the flow of water in the claimed structure.

4. According to claim number one, the number of sides of the claimed pyramid is variable and can be created starting from three faces to infinity.

5. According to claim number one, in these structures, the amount of electricity produced, the number of pumps and their flow rates are directly related to the turbines and generators of each floor, and the number of turbines and generators varies based on the calculation of the volume of water in each floor.

6. According to claim number one, the turbines are placed on the wall and in the lower part of each floor.

7. According to claim number one, in the claimed structure, there is a level meter device on each floor for each pool to measure the amount of water in the pool.

8. According to claim number one, based on the amount of water consumed by each floor in the pumping pipe route, one outlet is assigned to each floor and an electric valve is installed in each of these pipes to control the flow of water in each floor based on consumption.

9. According to claim number one, a pipe and an electric valve are installed at the head of the wall of each floor of the alleged structure to transfer the excess water that is collected in the pools to other floors.

10. According to claim number one and nine, the excess water output of the pools can also be used in case the turbines are damaged.

11. According to claim number one, in the claimed structure in order to increase the output efficiency, each turbine is connected to a gearbox that increases the rotation rate and transfers it to a generator.
